(19) United States
(12) Patent Application Publication
(10) Pub. No.: US 2017/0089741 A1
(43) Pub. Date: Mar. 30, 2017

(54) SIGNAL PROCESSING CIRCUIT FOR MEASURING MACHINE

(71) Applicant: MITUTOYO CORPORATION, Kawasaki-shi (JP)

(72) Inventors: Chihiro TAKAHASHI, Miyazaki-shi (JP); Toshihiro KANEMATSU, Miyazaki-shi (JP)

(73) Assignee: MITUTOYO CORPORATION, Kawasaki-shi (JP)

(21) Appl. No.: 15/270,688

(22) Filed: Sep. 20, 2016

(30) Foreign Application Priority Data
Sep. 29, 2015 (JP) 2015-190869

(51) Int. Cl. G01D 18/00

(52) U.S. Cl. CPC G01D 18/00

(57) ABSTRACT

There is provided a signal processing circuit, which improves a signal SN ratio, for a measuring machine. A sensor uses two or more reference signals processed so as to have a mutual predetermined phase difference. The signal processing circuit includes a phase correcting circuit which removes an offset due to a phase shift between the two or more reference signals. The phase correcting circuit includes an offset detecting unit which adds the two or more reference signals and extracts the offset, and a correction processing unit which removes the offset from a sensor signal.

### INCORPORATION BY REFERENCE

This application is based upon and claims the benefit of priority from Japanese patent application No. 2015-190869, filed on Sep. 29, 2015, the disclosure of which are incorporated herein in its entirety by reference.

### BACKGROUND OF THE INVENTION

1. Field of the Invention

The present invention relates to a signal processing circuit for a measuring machine.

2. Description of Related Art

There is known a sensor using a differential inductance, and a measuring machine using the sensor has been widely used (JP 4690110 B and JP 08-77282A). FIG. 1 is a signal processing circuit 10, which processes a sensor signal from a differential inductance 500, for a measuring machine.

The differential inductance 500 includes two coils 510 and 520, and a core 530 which moves relatively to the coils 510 and 520. The two coils 510 and 520 are disposed symmetrically with respect to the center position (neutral point) of the core 530, and connected serially with each other.

The core 530 displaces together with, for example, a measuring tool of a measuring machine, such as a spindle or a stylus. Reference signals input to the two coils 510 and 520 each have a phase opposite to each other.

For example, when it is assumed that one reference signal SA1 is sin θ, the other reference signal SA2 is “−sin θ”. The one reference signal is referred to as a first reference signal SA1, and the other reference signal which is an inversion signal of the first reference signal SA1 is referred to as a second reference signal SA2.

Furthermore, the connected point of the two coils 510 and 520 is referred to as a sensor signal output end.

The input end of the coil to which the first reference signal SA1 is input is referred to as a first reference signal input end.

The input end of the coil to which the second reference signal SA2 is input is referred to as a second reference signal input end.

The signal processing circuit 10 includes a first amplifier 110, a processing unit 120, a second amplifier 130, and an AD converter 140.

The first amplifier 110 amplifies the sensor signal.

The processing unit 120 performs rectifying (121), filtering (122), or the like to the sensor signal amplified by the first amplifier 110.

The second amplifier 130 amplifies the processed sensor signal according to the range of the AD converter 140.

If the same amplification factor is obtained, the first amplifier 110 is designed so as to be increase the amplification factor (GA) as much as possible.

This is because that the increased amplification factor of the first amplifier 110 is advantageous to the signal SN ratio. For example, it is assumed that the gain of the first amplifier 110 is GA, and the gain of the second amplifier 130 is GB. Then, the noise mixed in each processing is defined as illustrated in FIG. 1. It is assumed that the noise originally included in the sensor signal is eni.

Furthermore, it is assumed that the noises mixed in processing of the first amplifier 110, the processing unit 120, and the second amplifier 130 are en1, en2, en3, and en4, and that the noise included in the output signal of the second amplifier 130 is Eno.

The noise Eno is represented as follows:

Eno²=GB²{GA²(eni²+en1²)+en2²+en3²en4²}

It is advantageous to the SN ratio that the amplification factor (GA) of the first amplifier 110 is to be increased as much as possible and the amplification factor (GB) of the second amplifier 130 is to be reduced.

### SUMMARY OF THE INVENTION

Since the first reference signal SA1 (sin θ) and the second reference signal SA2 (−sin θ) each have a phase opposite to each other, the sensor signal (displacement voltage Z) is to be 0 V when the core 530 is positioned at the neutral point of the differential inductance 500.

However, the first reference signal (sin θ) is not a complete inversion signal of the second reference signal (−sin θ) actually, and the first reference signal SA1 (sin θ) and the second reference signal SA2 (−sin θ) has a slight phase shift. The shift is generated due to the delay inevitably caused by, for example, inverting the first reference signal (sin θ) to generate the second reference signal (−sin θ).

FIG. 2 is a diagram explaining an offset voltage due to a phase shift of the reference signal.

Here, it is assumed that the amplitude of the reference signal (sin θ) is, for example, 2.2 V. Furthermore, it is assumed that the phase shift between the first reference signal SA1 and the second reference signal SA2 is 2 degree. At this time, although the core 530 is positioned at the neutral point of the differential inductance 500, the offset voltage having the amplitude of 77 mV is generated.

Zo=2.2 sin θ+(−2.2 sin(θ−2))

When it is assumed that θ equals zero, Zo=(0+0.0767)=about 77 mV.

If the offset voltage is included as noise, the gain of the amplifier cannot be sufficiently increased. Especially, the gain of the first amplifier 110 which is effective for improving the SN ratio cannot be sufficiently increased. For example, when the operating voltage of 5 V is obtained, a 500 times gain is divided into two steps, and it is assumed that the gain of the first amplifier 110 is increased to be 100 times, and the gain of the second amplifier 130 is increased to be 5 times.

However, the operating voltage (5 V) of the following processing unit 120 is limited, and the gain of the first amplifier 110 cannot be increased to be up to about 60 times.

(5 V/77 mV=64.9)

Thus, it is difficult to improve the SN ratio, and thus it has been difficult to improve the resolution and the accuracy of the measuring machine.

For this reason, a purpose of the present invention is to provide a signal processing circuit, which improves a signal SN ratio by removing offset noise from a sensor signal before the sensor signal is input to a first amplifier, for a measuring machine.

A signal processing circuit for a measuring machine in an aspect of the present invention is the signal processing circuit, which receives, as measurement data, a sensor signal from a sensor using two or more reference signals processed so as to have a mutual predetermined phase difference, for the measuring machine, the signal processing circuit including:

a phase correcting circuit configured to remove an offset due to a phase shift between the two or more reference signals, in which

the phase correcting circuit includes:
an offset detecting unit configured to add the two or more reference signals and extract the offset; and
a correction processing unit configured to remove the offset from the sensor signal.

In an aspect of the present invention, the offset detecting unit and the correction processing unit may function as an adder/subtractor circuit which includes a common operational amplifier.

In an aspect of the present invention, it is preferable that:

a first amplifier is disposed so as to follow the phase correcting circuit;

a plurality of processing circuits is disposed so as to follow the first amplifier; and

a second amplifier is disposed so as to follow the plurality of processing circuits, in which

a gain of the first amplifier is increased as much as possible.

For example, the gain of the first amplifier is set to be 20 or 30 times the gain of the second amplifier, or more. Thus, it is possible to improve the signal SN ratio. Furthermore, by removing the offset of the sensor signal by the phase correcting circuit, it is possible to increase the gain of the first amplifier.

A measuring machine in an aspect of the present invention includes:

a sensor configured to use two or more reference signals processed so as to have a mutual predetermined phase difference; and

the signal processing circuit for the measuring machine.

### BRIEF DESCRIPTION OF THE DRAWINGS

FIG. 1 is a diagram illustrating a signal processing circuit, which processes a sensor signal, for a measuring machine;

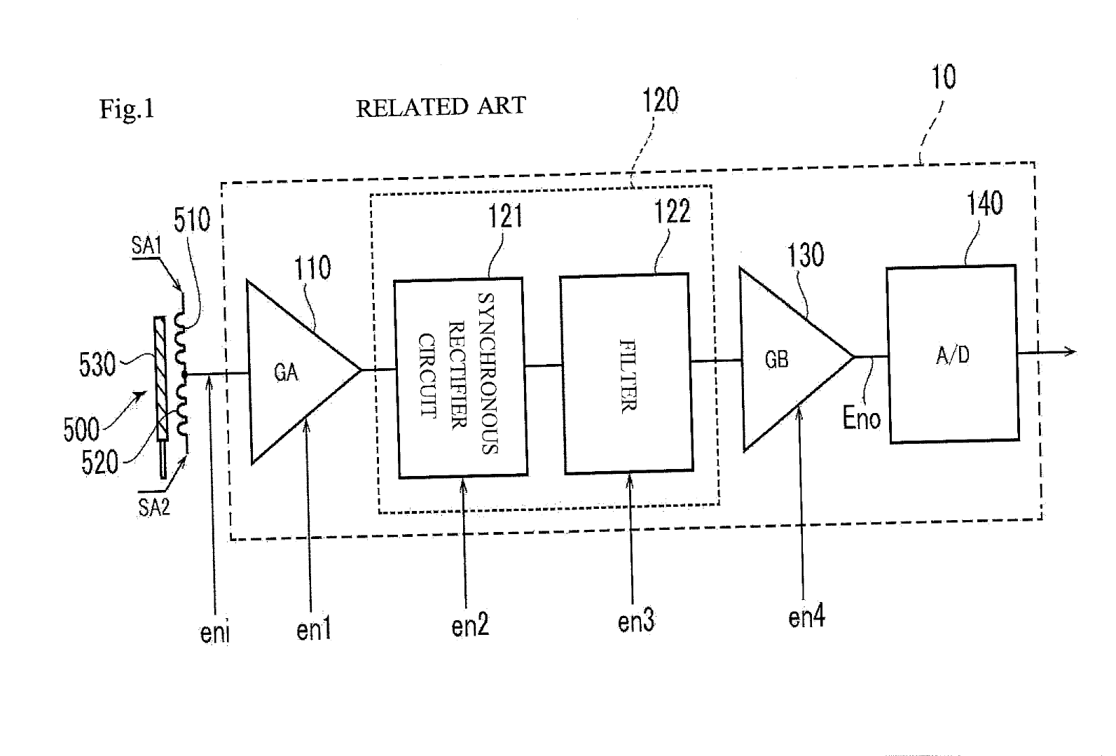

FIG. 2 is a diagram explaining an offset voltage due to a phase shift of a reference signal;

FIG. 3 is a diagram illustrating a signal processing circuit according to a first exemplary embodiment of the present invention;

FIG. 4 is a diagram illustrating a specific configuration example of a phase correcting circuit; and

FIG. 5 is a diagram illustrating a modified example 1.

### DETAILED DESCRIPTION

An embodiment of the present invention is illustrated and is described with reference to the reference signs attached to the elements of the drawings.

### First Exemplary Embodiment

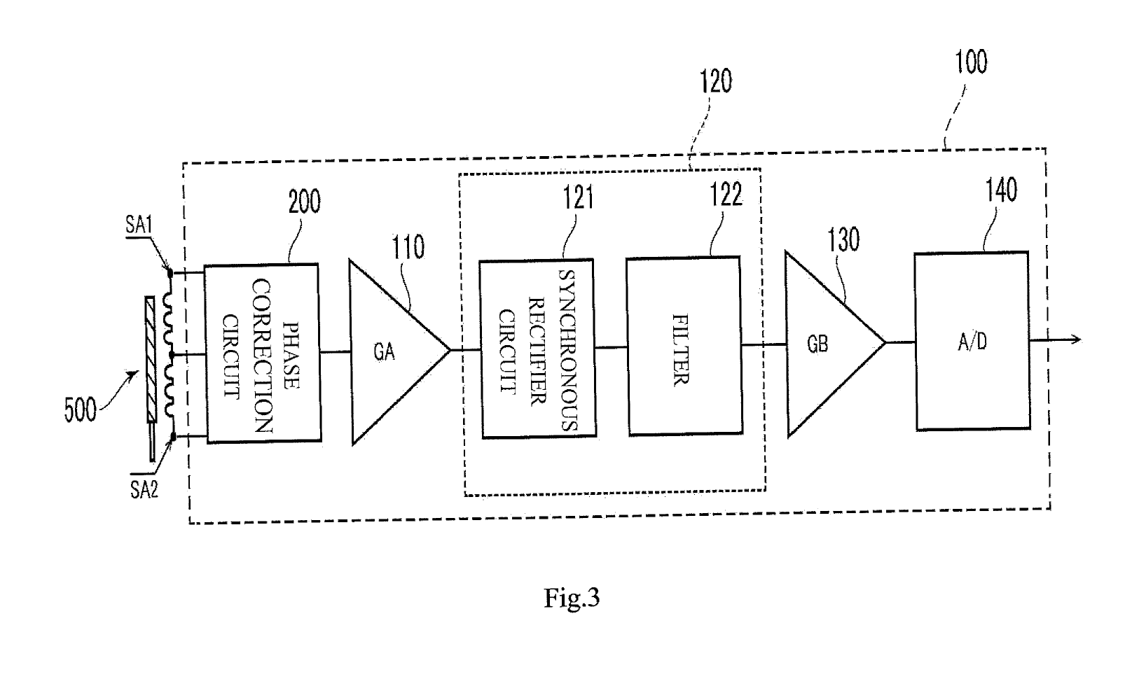

FIG. 3 a diagram illustrating a signal processing circuit 100 according to a first exemplary embodiment of the present invention.

A feature of the present exemplary embodiment is to dispose a phase correction circuit 200 so as to precede a first amplifier 110. In other words, a sensor signal from a sensor 500 is subjected to correction processing by the phase correction circuit 200 and then input to the first amplifier 110.

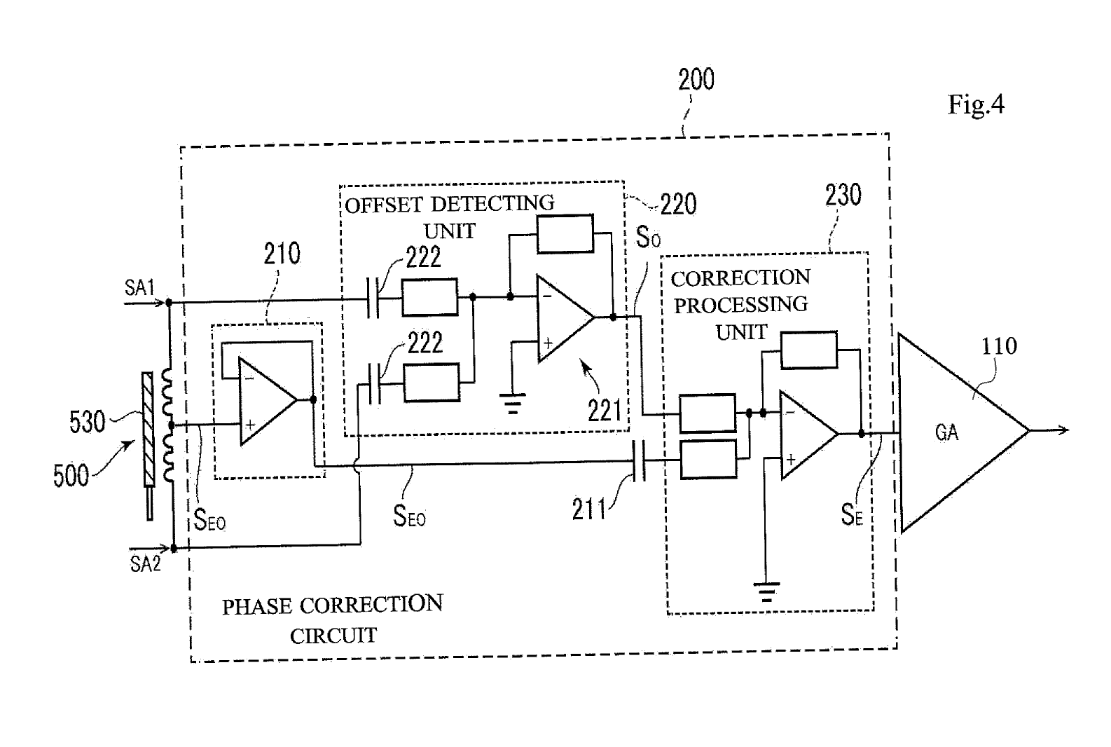

FIG. 4 is a diagram illustrating a specific configuration example of the phase correction circuit 200.

The phase correction circuit 200 includes a sensor signal input unit 210, an offset detecting unit 220, and a correction processing unit 230.

The sensor signal input unit 210 is connected to the sensor signal output end of the sensor 500, and receives a sensor signal S_{EO} from the sensor 500. The sensor signal input unit 210 outputs the received sensor signal S_{EO} to the correction processing unit 230.

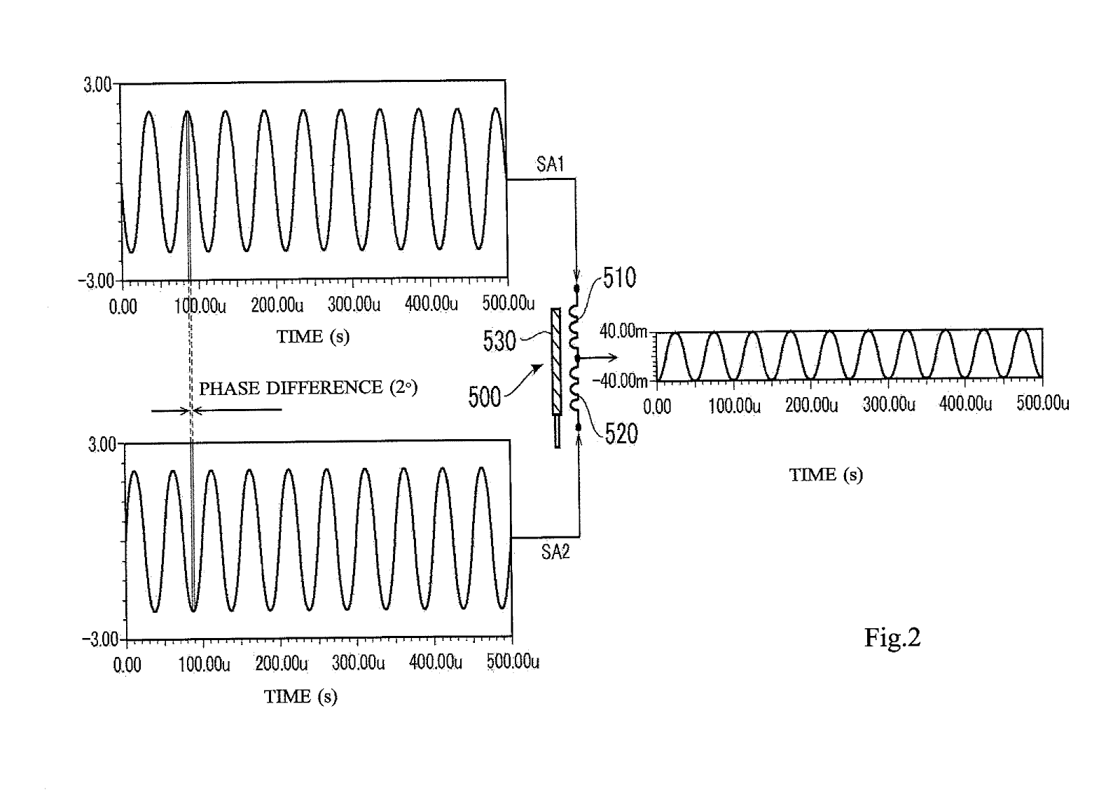

Here, the sensor signal S_{EO} varies according to the displacement of the core 530. However, when there is a phase shift between a first reference signal SA1 and a second reference signal SA2, the signal includes the offset due to the phase shift (for example, see FIG. 2).

Note that, the sensor signal input unit 210 is a non-inverting amplifier circuit (voltage follower) having a one-time gain, and is what is called a buffer to match the impedance with that of other circuits.

Furthermore, a coupling capacitor 211 is disposed between the sensor signal input unit 210 and the correction processing unit 230 to remove the DC level.

The offset detecting unit 220 includes two input ends and an adder circuit 221. The two input ends are referred to as a first input end and a second input end.

The first input end is connected with the first reference signal input end of the sensor 500. In other words, the first reference signal SA1 is input to the first input end similarly to the sensor 500.

The second input end is connected with the second reference signal input end of the sensor 500. In other words, the second reference signal SA2 is input to the second input end similarly to the sensor 500.

The first input end and the second input end are connected with the adder circuit 221. Note that, a coupling capacitor 222 to remove the DC level is each disposed between the first input end and the adder circuit 221, and between the second input end and the adder circuit 221. The first reference signal SA1 and the second reference signal SA2 are added by the adder circuit 221.

When the first reference signal SA1 has an ideal phase opposite to the phase of the second reference signal SA2, the output from the adder circuit 221 is to be constantly 0 V.

When there is a phase shift between the first reference signal SA1 and the second reference signal SA2, the output from the adder circuit 221 is to be a signal equivalent to the offset due to the phase shift (see FIG. 2). Thus, the output signal from the adder circuit 221 (the offset detecting unit 220) is referred to as an offset signal So. The offset signal So from the adder circuit 221 is input to the correction processing unit 230.

The correction processing unit 230 performs correction processing to remove the offset from the sensor signal S_{EO} by removing the offset signal So from the sensor signal S_{EO}.

Thus, a sensor signal S_{E} from which the offset is removed is obtained.

If the sensor itself includes an offset, the signal processing circuit 100 according to the present embodiment can remove the offset from the sensor signal S_{EO}.

Thus, when a sensor 500 is selected, the sensor 500 having high quality is not necessarily used, and it is possible to reduce the cost of the measuring machine. Furthermore, since the sensor signal SE without an offset is obtained, the amplification factor (GA) of the first amplifier 110 can be ideally increased.

For example, in such a manner that the gain of the first amplifier 110 is increased to be 100 times and the gain of the second amplifier 130 is increased to be 5 times, the gain of the first amplifier 110 is sufficiently increased.

### Modified Example 1

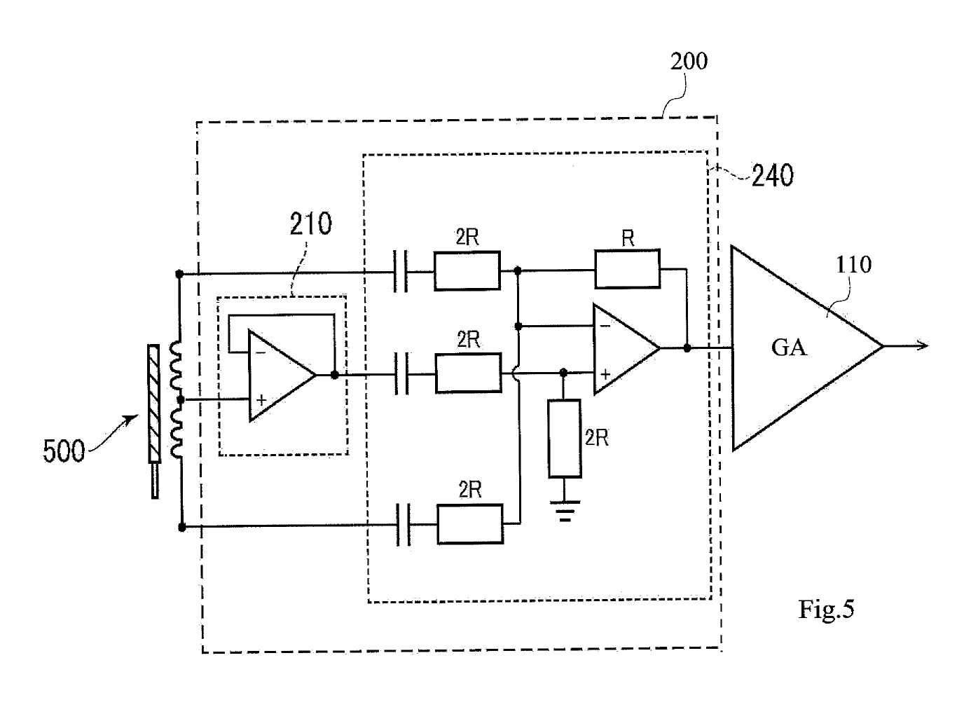

A modified example 1 is illustrated in FIG. 5.

In the modified example 1, the offset detecting unit 220 and the correction processing unit 230 have a common operational amplifier, and an effect similar to the first exemplary embodiment can be obtained.

The offset detecting unit 220 and the correction processing unit 230 are integrated and function as an adder/subtractor circuit 240.

With this configuration, it is possible to obtain an effect similar to the first exemplary embodiment, and to miniaturize the signal processing circuit since the components are reduced.

Note that, the present invention is not limited to the above embodiment, and can be appropriately changed without deviating from the scope.

The differential inductance has been exemplified as the sensor, but a type of the sensor is not especially limited.

The sensor is only required to use two reference signals each having a phase opposite to each other.

Alternatively, the sensor is only required to use a plurality of reference signals processed so as to have a mutual predetermined phase difference instead of the two reference signal each having a phase opposite to each other.

1. A signal processing circuit, which receives, as measurement data, a sensor signal from a sensor using two or more reference signals processed so as to have a mutual predetermined phase difference, for a measuring machine, the signal processing circuit comprising:
a phase correcting circuit configured to remove an offset due to a phase shift between the two or more reference signals, wherein
the phase correcting circuit comprises:
an offset detecting unit configured to add the two or more reference signals and extract the offset; and
a correction processing unit configured to remove the offset from the sensor signal.

2. The signal processing circuit for the measuring machine according to claim 1, wherein the offset detecting unit and the correction processing unit function as an adder/subtractor circuit which includes a common operational amplifier.

3. The signal processing circuit for the measuring machine according to claim 1 further comprising:
a first amplifier disposed so as to follow the phase correcting circuit;
a plurality of processing circuits disposed so as to follow the first amplifier; and
a second amplifier disposed so as to follow the plurality of processing circuits, wherein
a gain of the first amplifier is set to a maximum value which the plurality of processing circuits tolerates as much as possible.

4. A measuring machine comprising:
a sensor configured to use two or more reference signals processed so as to have a mutual predetermined phase difference; and
the signal processing circuit for the measuring machine according to claim 1.
